(19) United States
(12) Patent Application Publication
(10) Pub. No.: US 2014/0304143 A1
(43) Pub. Date: Oct. 9, 2014

(54) ELECTRONIC CHECK CASHING SYSTEM

(71) Applicant: Certegy Check Services, Inc., St. Petersburg, FL (US)

(72) Inventor: Mandi C. HART, Tampa, FL (US)

(73) Assignee: Certegy Check Services, Inc., St. Petersburg, FL (US)

(21) Appl. No.: 14/194,654

(22) Filed: Feb. 28, 2014

Related U.S. Application Data
(63) Continuation of application No. 12/209,004, filed on Sep. 11, 2008, now abandoned.

(51) Int. Cl. G06Q 20/04

(52) U.S. Cl. CPC G06Q 20/0425; G06Q 40/025
USPC 705/38

(57) ABSTRACT

Methods and systems for cashing electronic checks are disclosed. One method includes receiving credential information from a user at an automated system communicatively connected to a checking account information database, and validating the credential information. The method further includes obtaining checking account information from the checking account information database, the checking account information corresponding to a checking account associated with the credential information and having been at least partially previously entered into the checking account information database from a system separate from the automated system. The method also includes receiving a request to cash an electronic check, and determining whether to fulfill the request to cash the electronic check.

### TECHNICAL FIELD

The present disclosure relates generally to financial transactions; in particular, the present disclosure relates to an electronic check cashing system.

### BACKGROUND

When an individual wishes to cash a check, that user generally either writes a personal check or endorses a check received from another party. That check is then presented by the user to a financial institution or business, which generally returns currency to the individual and forwards the check to its issuing institution. The funds are reimbursed from the issuing institution to the financial institution or business cashing the check for the individual. The funds reimbursement portion of the check cashing process, or “settlement” generally takes a number of days to occur, due in part to physical transportation of the check from the check cashing institution to the issuing institution.

Recently, electronic check cashing systems, and regulations for use of those systems, have developed which hasten the above process by allowing the institution cashing the check to digitize information for transmission between check cashing institutions and issuing institutions. These electronic “Automated Clearing House” (ACH) transactions have a number of advantages. For example, the time for settlement to occur is dramatically reduced, because of the reduced time required to transmit check information between the check cashing institution and the issuing institution.

Existing electronic check cashing systems that perform ACH transactions generally operate through capture of information from a check. Systems configured to perform such transactions generally require manually submitting a check by the individual seeking to cash the check. Also, even with this improved settlement time, many existing systems do not assess whether to cash the check (e.g. by verifying funds exist in the account).

In certain recurring situations, an individual seeking to cash a check readily knows information about the account from which funds are sought. One example is a situation in which the individual is seeking to access funds in his/her own account. Even in this situation, the individual generally must write a check or key in information about a check (e.g. account and routing information) for electronic withdrawal.

For these and other reasons, improvements are desirable.

### SUMMARY

In accordance with the following disclosure, the above and other problems are solved by the following:

In a first aspect, a method for cashing electronic checks is disclosed. The method includes receiving credential information from a user at an automated system communicatively connected to a checking account information database, and validating the credential information. The method further includes obtaining checking account information from the checking account information database, the checking account information corresponding to a checking account associated with the credential information and having been at least partially previously entered into the checking account information database from a system separate from the automated system. The method also includes receiving a request to cash an electronic check, and determining whether to fulfill the request to cash the electronic check.

In a second aspect, a computer storage medium having computer-executable modules configured to assist in electronically cashing a check is disclosed. The computer storage medium stores modules including a credential receipt module configured to receive credential information from a user at an automated system communicatively connected to a checking account information database, and a validation module configured to validate the credential information received by the credential receipt module. The computer storage medium also stores modules including an information module configured to obtain checking account information from the checking account information database, the checking account information corresponding to a checking account associated with the credential information and having been at least partially previously entered into the checking account information database from a system separate from the automated system. The computer storage medium also stores modules including a request receipt module configured to receive a request to cash an electronic check drawn on the checking account and a determination module configured to determine whether to cash the electronic check.

In a third aspect, a system for cashing an electronic check is disclosed. The system includes a computing system configured to execute program instructions to receive credential information from a user and validate the credential information. The computing system is also configured to execute program instructions to obtain checking account information from a checking account information database remote from the system, the checking account information corresponding to a checking account associated with the credential information and having been at least partially previously entered into the checking account information database independently from the computing system. The computing system is further configured to execute program instructions to receive a request to cash an electronic check, and receive a determination of whether to cash the electronic check.

In a fourth aspect, a method of cashing an electronic check is disclosed. The method includes receiving an identification number and security code from a user at an automated system communicatively connected to a checking account information database, and validating the identification number and security code. The method also includes obtaining checking account information from the checking account information database, the checking account information corresponding to one or more checking accounts associated with the credential information and having been at least partially previously entered into the checking account information database from a system separate from the automated system. The method further includes prompting the user to select a checking account from among the one or more checking accounts. The method includes receiving an indication from the user identifying the checking account to be accessed from among the one or more checking accounts, and receiving a request to cash an electronic check associated with the checking account. The method also includes performing a risk assessment on the request to cash an electronic check to determine an amount of funds allowed to be withdrawn within a predetermined period of time, performing an automated clearing house transaction to cash the electronic check, and triggering disbursement of the funds to the user from the automated system.

### BRIEF DESCRIPTION OF THE DRAWINGS

FIG. 1 is a flowchart of methods and systems for cashing an electronic check, according to a possible embodiment of the present disclosure;

FIG. 2 is a network illustrating an example location in which aspects of the present disclosure can be implemented;

FIG. 3 is a block diagram of a generalized computing system usable to implement aspects of the present disclosure;

FIG. 4 is a flowchart illustrating a subsection of one example process for cashing an electronic check, according to a possible embodiment of the present disclosure;

FIG. 5 is a further flowchart illustrating a further subsection of an example process for cashing an electronic check, useable in conjunction with the subsection of FIG. 4;

FIG. 6 is a further flowchart illustrating a further subsection of an example process for cashing an electronic check, useable in conjunction with the subsection of FIG. 4;

FIG. 7 illustrates an example graphical user interface for cashing an electronic check, useable in certain embodiments of the checking account withdrawal system of the present disclosure;

FIG. 8 illustrates an example graphical user interface for entering user credentials, useable in certain embodiments of the electronic check cashing systems of the present disclosure;

FIG. 9 illustrates a further example graphical user interface for entering user credentials, useable in certain embodiments of the electronic check cashing system of the present disclosure;

FIG. 10 illustrates an example graphical user interface presentable during a login processing stage, useable in certain embodiments of the electronic check cashing system of the present disclosure;

FIG. 11 illustrates an example graphical user interface for selecting an account, useable in certain embodiments of the electronic check cashing system of the present disclosure;

FIG. 12 illustrates an example graphical user interface for selecting an amount relating to an electronic checking withdrawal, useable in certain embodiments of the electronic check cashing system of the present disclosure;

FIG. 13 illustrates an example graphical user interface for confirming a transaction relating to an electronic checking withdrawal, useable in certain embodiments of the electronic check cashing of the present disclosure;

FIG. 14 illustrates an example graphical user interface displaying notice provisions relating to an electronic checking withdrawal, useable in certain embodiments of the electronic check cashing system of the present disclosure;

FIG. 15 illustrates an example graphical user interface presentable during a transaction processing stage, useable in certain embodiments of the electronic check cashing system of the present disclosure;

FIG. 16 illustrates an example graphical user interface presentable after approval of an electronic check withdrawal, useable in certain embodiments of the electronic check cashing system of the present disclosure;

FIG. 17 illustrates an example graphical user interface requesting a withdrawal amount reentry, useable in certain embodiments of the electronic check cashing of the present disclosure;

FIG. 18 illustrates an example graphical user interface reporting a validation error, useable in certain embodiments of the electronic check cashing system of the present disclosure;

FIG. 19 illustrates an example graphical user interface reporting improper card usage, useable in certain embodiments of the electronic check cashing system of the present disclosure;

FIG. 20 illustrates an example graphical user interface reporting a connection error, useable in certain embodiments of the electronic check cashing system of the present disclosure;

FIG. 21 illustrates an example graphical user interface requesting reentry of identification number information, useable in certain embodiments of the electronic check cashing system of the present disclosure;

FIG. 22 illustrates an example graphical user interface reporting incorrectly entered identification number information, useable in certain embodiments of the electronic check cashing system of the present disclosure;

FIG. 23 illustrates an example graphical user interface requesting reentry of an identification code, useable in certain embodiments of the electronic check cashing system of the present disclosure;

FIG. 24 illustrates a further example graphical user interface reporting incorrectly entered credentials, useable in certain embodiments of the electronic check cashing system of the present disclosure;

FIG. 25 illustrates an example graphical user interface for a credential disabling message, useable in certain embodiments of the electronic check cashing system of the present disclosure;

FIG. 26 illustrates an example graphical user interface for reporting an unauthorized or rejected transaction, useable in certain embodiments of the electronic check cashing system of the present disclosure; and

FIG. 27 illustrates an example graphical user interface for a canceled transaction, useable in certain embodiments of the electronic check cashing system of the present disclosure.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

The present disclosure relates generally to methods and systems for enabling electronic checking withdrawals, such as by cashing electronic checks. By electronic checking withdrawals, the present disclosure is intended to relate to electronically submitted check transactions that proceed through a check clearance process, as opposed to direct access and withdrawal of funds from a checking account. The present disclosure operates by accessing previously-received electronic checking information related to checking accounts (e.g. routing and account numbers, and known past activity). The methods and systems used herein generally can be performed by any system, whether affiliated with or unaffiliated with a user's issuing financial institution.

The logical operations of the various embodiments of the present disclosure described herein are implemented as: (1) a sequence of computer implemented operations running on a computing system; and/or (2) interconnected machine modules within the computing system. Modules represent functions executed by program code such as commonly available programming languages or as the code found in a dynamic-link library (DLL). The implementation used is a matter of choice dependent on the performance requirements of the system overall and the computing systems with which it interfaces. Accordingly, the logical operations making up the embodiments of the present disclosure can be referred to alternatively as operations, modules, and the like.

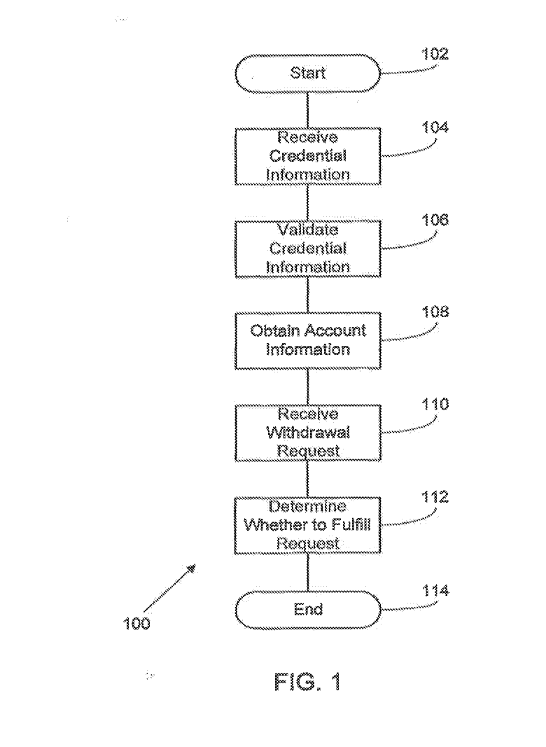

Referring now to FIG. 1, a flowchart of methods and systems for operation of checking account withdrawal system is shown according to a possible embodiment of the present disclosure. The methods and systems 100 illustrate a process by which checking account funds can be withdrawn, such as by cashing an electronic check, in a manner analogously to cashing a personal check. The system 100 is instantiated at a start operation 102, which corresponds to initial setup of a system for electronic check cashing, including one or more automated systems arranged for user interaction at a gaming establishment or other place of business. In certain embodiments, the automated system can be one of a number of automated systems, and can be communicatively connected to a checking account information database, which can be local to or remote from the automated system.

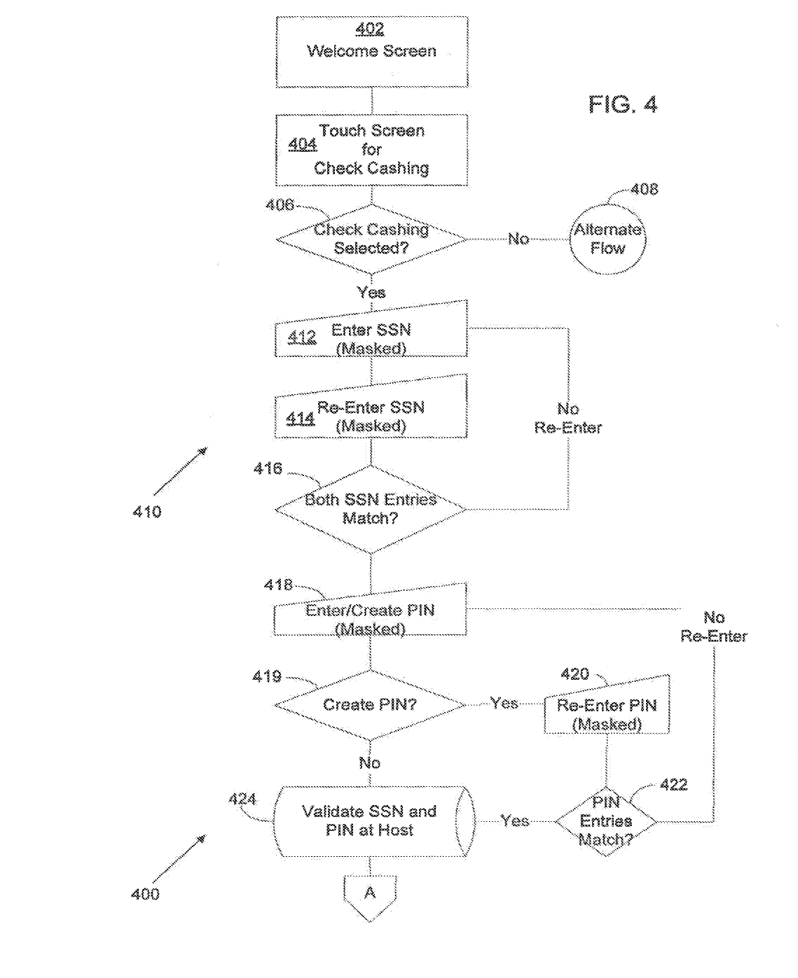

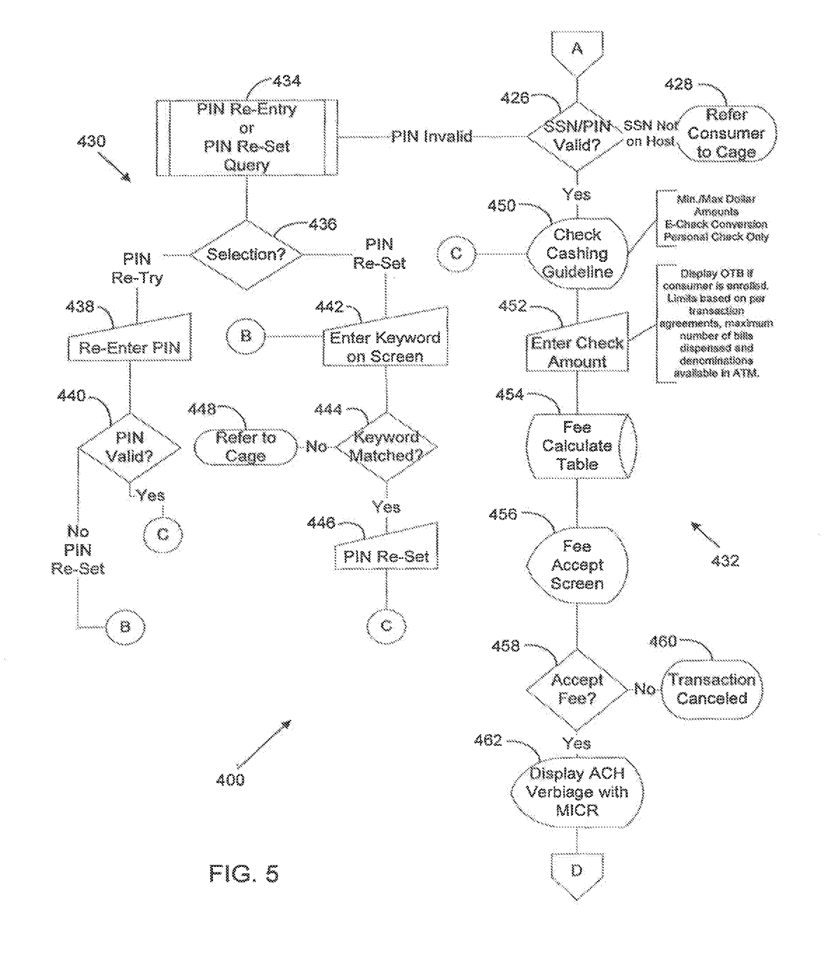

Operational flow proceeds to a credential receipt module 104, which is configured to receive credential information from a user at the automated system. The credential receipt module 104 receives information from the user, including an identification number and an identification code, such that the user's identity can be reliably and securely established. In certain embodiments, the credential information received from the user can include the user's social security number (SSN) and a PIN number established by the user. Other credential information can be collected as well, such as birthdate information, driver's license information, passwords, or other identifying information, as described in FIGS. 4-5 below.

In some embodiments, the credential receipt module 104 receives input of the credential information at a keyboard or touchscreen module associated with the automated system; in other embodiments, an identification card carried by the user can be inserted into the automated system to provide the credential information. Other possible input devices and methodologies exist as well.

In some further embodiments, the credential receipt module 104 requires input of credential information more than once to verify the accuracy of the credential information. In further embodiments, the credential receipt module 104 allows receipt of credential information after an initial failed operation at the validation module 106, below, to allow a user to re-enter credential information. In such embodiments, the credential receipt module 104 can allow a predetermined number of credential information reentries prior to locking an account due to suspected fraudulent or suspicious use.

Operational flow proceeds to a validation module 106, which corresponds to validating the credential information received at the automated system. The validation module 106 compares the credential information to information stored in a checking account information database to determine whether the provided credential information matches information associated with one or more personal checking accounts associated with the automated system. In some embodiments, the validation module 106 can do so by transmitting the credential information to a remote system hosting the checking account information database, and receiving confirmation of acceptance of the credential information by that remote system. In other embodiments, the validation module 106 operates on locally-stored information received from a checking account information database. Other configurations are possible as well.

Operational flow proceeds to an account information module 108, which displays account information to a user following successful performance of the validation module. The account information module displays information related to one or more personal checking accounts to the user, to allow user selection of one of the accounts to effect a funds withdrawal (i.e. by forming an electronic check based on information received from the user and from the accessed checking account information). The account information module 108 can display any of a variety of information about the account, such as the account number, associated banking institution, and predetermined withdrawal limits with respect to that account. Operational flow proceeds to a withdrawal request module 110 that receives a withdrawal request from the user relating to one of the accounts, in which the user selects an account and forms an electronic check used in a request for a withdrawal of money from that account. The withdrawal request module 110 can be configured to receive electronic checks of a variety of values; in certain embodiments, only predetermined increments (e.g. by $20 increments) can be accepted based on the stocked currency in the automated system.

Operational flow proceeds to a determination module 112, which determines whether to fulfill the request to withdraw funds from the selected checking account. The determination module 112 can operate in a number of ways. For example, in some embodiments, the determination module 112 corresponds to a risk assessment procedure performed on a checking account which determines a maximum reliable amount of money withdrawn from the account based on a variety of factors, such as the periods and amounts of deposits and withdrawals, average balances, credit history of the account holder, or other factors. In other embodiments, the determination module 112 uses a current or last-known balance in the checking account to determine whether to fulfill the request to withdraw funds. Other possibilities can exist as well.

Operational flow terminates at an end operation 114, which corresponds, in certain embodiments, to completion of the system 100.

A number of additional operations can be performed within the system 100 as well, as described in the methods and systems of FIGS. 4-6, below. For example, additional modules relating to disbursement of funds, receipt of credential information, withdrawal processing, and error cases can be implemented. For example, a withdrawal module can trigger an electronic check cashing operation to withdraw funds from the selected checking account, and a disbursement module can trigger disbursement of those funds to the user. Examples of other optional additional modules are described in conjunction with FIGS. 4-6, below.

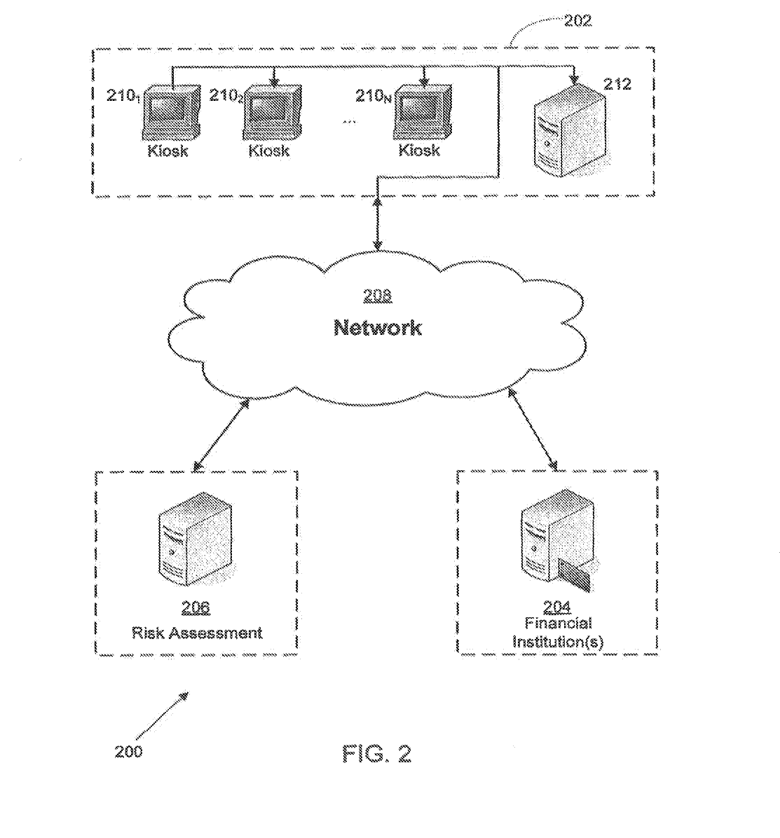

FIG. 2 shows a network 200, which represents an example arrangement in which aspects of the present disclosure can be implemented. The network 200 generally includes three major functional components or locations; a transaction location 202, a financial institution 204, and a risk assessment location 206. These components are interconnected at a network 208, as described below.

The transaction location 202 generally corresponds to a location at which a user wishes to cash an electronic check. The transaction location 202 can be any of a number of locations, such as a gaming establishment or other entertainment or product/service sales location. The transaction location 202 includes a plurality of automated systems 210_{1-N} that can be used by a user at the location to cash the electronic check. In the embodiment shown, the automated systems 210_{1-N} are interconnected to a local management computing system 212, which can provide localized storage of user information (e.g. local account information) common to the automated systems. The local management computing system 212 can, in certain applications of the present system, be managed by the proprietor of the transaction location 202 or other party, to collect data associated with potential users of the automated systems. The local management computing system 212 can collect information relating a user to one or more checking accounts, login information specific to the location 202, financial history at the location 202, and other data. In one example in which the local management computing system 212 is placed in a gaming environment, the local management computing system 212 can operate using on the Certegy E-CAGE system platform, as supplied by Fidelity National Information Services, Inc. of St. Petersburg, Fla. Other operational platforms can be used as well, in other locations.

The financial institution 204 corresponds to any one or more financial institutions managing a checking account for a customer, such as a customer who wishes to access funds in the checking account from the transaction location 202. The financial institution generally provides information to either computing systems at the transaction location 202 or the risk assessment location 206 (described below) relating to the account of the user, such that an informed decision can be made as to whether to allow the user to withdraw funds from his/her account. For example, information about the average balance of the account, the average deposits/withdrawal related to the account, the credit-worthiness of the account holder, and other information about the account that would assist in assessing whether to allow a withdrawal from the account without actually accessing a current balance of the account. This information can be transmitted periodically (e.g. monthly, weekly, or some other measure) to other parties (e.g. the risk assessment location 206, below) to provide knowledge about general characteristics of the account, and avoid having to specifically access the account each time a request for funds is made to verify that those specific funds exist in the account at the time.

The risk assessment location 206 corresponds to an entity that performs risk assessment on transaction requests received from the transaction location 202. The risk assessment location 206 provides an indication of approval or disapproval of a request made by a user at the transaction location regarding a request to withdraw funds from an account at one or more of the financial institutions 204, based on a number of factors, depending on the information received from the financial institution related to the account to be accessed. For example, the risk assessment location 206 can assess the average balance in the account over a past timeframe, or can choose to use the credit score of the user associated with the account. Other factors can be used as well.

The risk assessment location 206 can include computing systems operating a web service configured to receive and assess web transactions indicative of requests for funds from personal checking accounts. The risk assessment location 206 can be configured to accordingly encrypt, address, and transmit the assessments, returning an indication to the transaction location 202 (and the specific kiosk or computing system from which the transaction was received) of the success/failure of the transaction, as well as fees charged.

Although in the embodiment shown the risk assessment location 206 is a stand-alone entity, in certain embodiments, operations occurring at the risk assessment location 206 are incorporated locally at the transaction location 202. In further embodiments, these operations can be incorporated at one or more of the financial institutions. For example, in certain embodiments of the present disclosure, account information is stored in a user database, which links user credential information (e.g. identification codes, such as social security numbers, and identification numbers, such as PIN numbers) to accounts held by financial institutions. The account information can be stored locally at the transaction location 202 (e.g. by the local management computing system 212) or on a server computer at the risk assessment location 206. Other arrangements are possible as well.

The network 208 provides a method for communication of information among the transaction location 202, the financial institutions 204, and the risk assessment location 206. The network can be, in various embodiments, any combination of wired or wireless telecommunication systems, such as IP or other packet-based networks, the Internet, a cellular data communication network or other communication networks.

Although the overall network 200 is shown as including three major functional components (i.e. the transaction location 202, financial institution 204, and risk assessment location 206), other functional components can be included as well. Furthermore, the functional components can be combined at one or more locations, such that the financial institution 204 can perform all or some of the functions described as occurring at the risk assessment location 206, or vice versa. Furthermore, certain operations can be combined at the transaction location 202 as well.

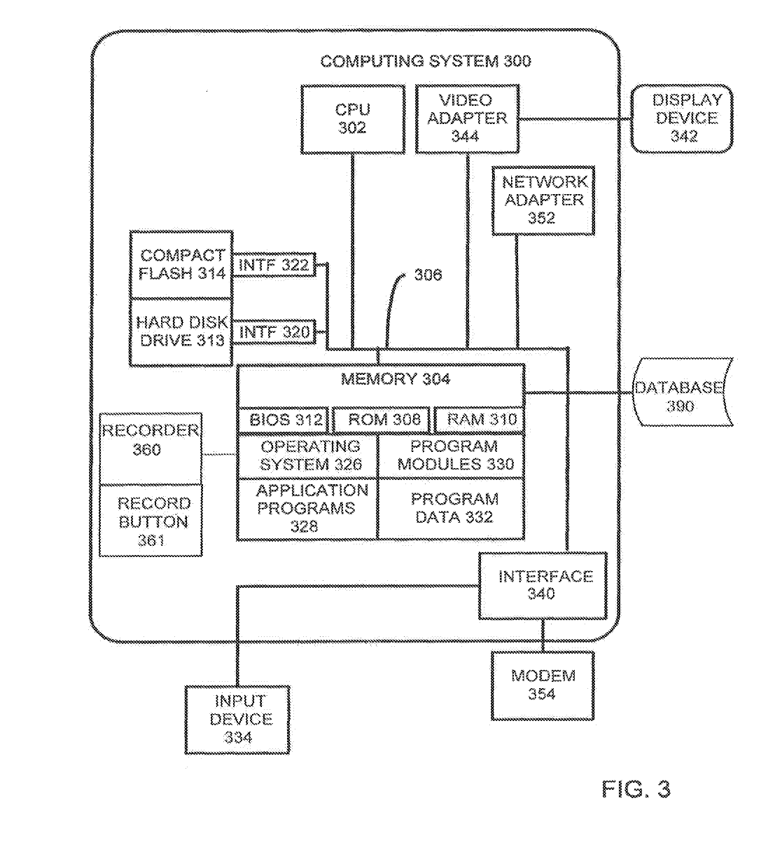

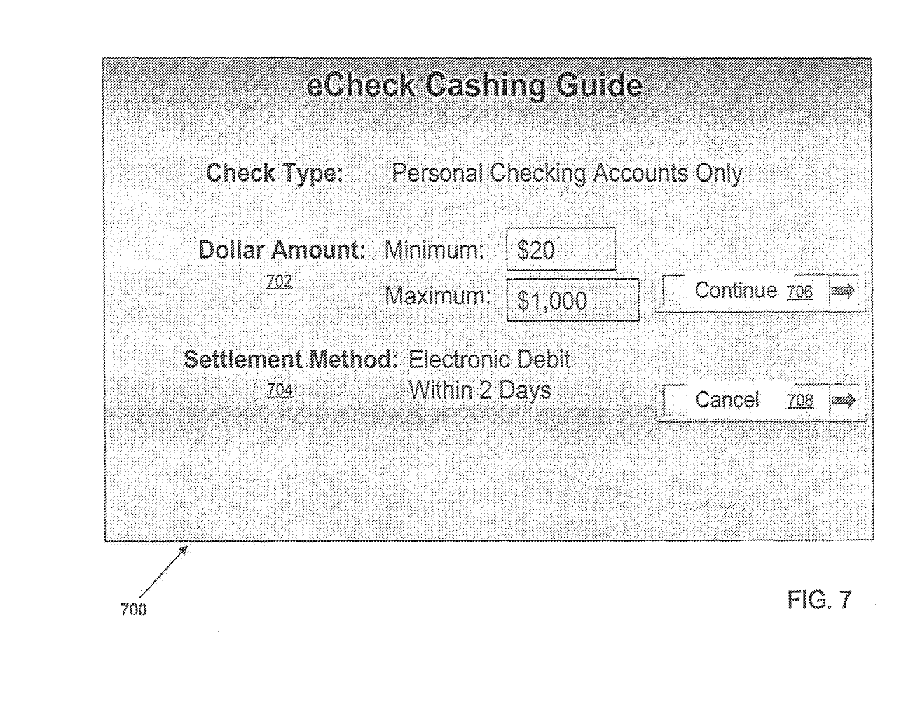

Referring to FIG. 3, an exemplary environment for implementing embodiments of the present disclosure includes a general purpose computing device in the form of a computing system 300, including at least one processing system 302. In the various embodiments described herein, the general purpose computing device can correspond to the various computing devices of FIG. 2, such as that of the transaction location 202, financial institutions 204, or risk assessment location 206. The computing system 300 can provide functionality for performing aspects of the present disclosure reflected in the systems and methods disclosed in FIG. 1 and FIGS. 4-6, and/or for displaying the graphical user interfaces of FIGS. 7-27. A variety of processing units 302 are available from a variety of manufacturers, for example, Intel or Advanced Micro Devices. The computing system 300 also includes a system memory 304, and a system bus 306 that couples various system components including the system memory 304 to the processing unit 302. The system bus 306 might be any of several types of bus structures including a memory bus, or memory controller, a peripheral bus; and a local bus using any of a variety of bus architectures.

Preferably, the system memory 304 includes read only memory (ROM) 308 and random access memory (RAM) 310. A basic input/output system 312 (BIOS), containing the basic routines that help transfer information between elements within the computing system 300, such as during start up, is typically stored in the ROM 308.

Preferably, the computing system 300 further includes a secondary storage device 313, such as a hard disk drive, for reading from and writing to a hard disk (not shown), and/or a compact flash card 314.

The hard disk drive 313 and compact flash card 314 are connected to the system bus 306 by a hard disk drive interface 320 and a compact flash card interface 322, respectively. The drives and cards and their associated computer readable media provide nonvolatile storage of computer readable instructions, data structures, program modules and other data for the computing system 300.

Although the exemplary environment described herein employs a hard disk drive 313 and a compact flash card 314, it should be appreciated by those skilled in the art that other types of computer-readable media, capable of storing data, can be used in the exemplary system. Examples of these other types of computer-readable mediums include magnetic cassettes, flash memory cards, digital video disks, Bernoulli cartridges, CD ROMS, DVD ROMS, random access memories (RAMs), read only memories (ROMs), and the like.

A number of program modules may be stored on the hard disk drive 313, compact flash card 314, ROM 308, or RAM 310, including an operating system 326, one or more application programs 328, other program modules 330, and program data 332. A user may enter commands and information into the computing system 300 through an input device 334. Examples of input devices might include a keyboard, mouse, microphone, joystick, game pad, satellite dish, scanner, digital camera, touch screen, and a telephone. These and other input devices are often connected to the processing unit 302 through an interface 340 that is coupled to the system bus 306. These input devices also might be connected by any number of interfaces, such as a parallel port, serial port, game port, or a universal serial bus (USB). A display device 342, such as a monitor or touch screen LCD panel, is also connected to the system bus 306 via an interface, such as a video adapter 344. The display device 342 might be internal or external. In addition to the display device 342, computing systems, in general, typically include other peripheral devices (not shown), such as speakers, printers, and palm devices. The computing system 300 can also interface with an external database 350, such as a data store resident on a separate computer or peripheral device.

When used in a LAN networking environment, the computing system 300 is connected to the local network through a network interface or adapter 352. When used in a WAN networking environment, such as the Internet, the computing system 300 typically includes a modem 354 or other means, such as a direct connection, for establishing communications over the wide area network. The modem 354, which can be internal or external, is connected to the system bus 306 via the interface 340. In a networked environment, program modules depicted relative to the computing system 300, or portions thereof, may be stored in a remote memory storage device. It will be appreciated that the network connections shown are exemplary and other means of establishing a communications link between the computing systems may be used.

The computing system 300 might also include a recorder 360 connected to the system memory 304. The recorder 360 includes a microphone for receiving sound input and is in communication with the system memory 304 for buffering and storing the sound input. Preferably, the recorder 360 also includes a record button 361 for activating the microphone and communicating the sound input to the system memory 304.

A computing device, such as computing system 300, typically includes at least some form of computer-readable media. Computer readable media can be any available media that can be accessed by the computing system 300. By way of example, and not limitation, computer-readable media might comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by the computing system 300.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as computer program product.

Referring now to FIGS. 4-6, a process 400 for cashing an electronic check is shown, according to a possible embodiment of the present disclosure. The process 400 can be, in various embodiments, embodied as a stand-alone software product or module to be added into a larger software product for providing remote access to funds, as well as hardware and mechanical systems enabling data communication and disbursement of funds to a user, such as can be found in a kiosk 210 or other computing system as described in FIG. 2, above.

FIG. 4 illustrates a subsection of the example process 400 for electronic check cashing, according to a possible embodiment of the present disclosure. The process 400 begins at a welcome screen module 402, which generates and displays to a user a welcome message at a transaction location. For example, the welcome screen module 402 can generate a display at one or more kiosks of a transaction location, as described in conjunction with FIG. 2 above, and can indicate a type of transaction (e.g. a checking account withdrawal) available at the kiosk. A touch screen module 404 detects a user touching the display displaying the welcome message, or otherwise touching a keyboard of a computing system associated with the display, indicating that a user would like to initiate a financial transaction at the transaction location.

A check cashing operation 406 determines whether the user wishes to perform an electronic check cashing operation, such as by presenting a number of financial transaction options to the user (e.g. checking account balances, credit, past transactions, credit-card based transactions, point-of-sale debit transactions, etc.) and receiving a user selection in response to the presentment of options. One example user interface presentable by the check cashing operation for validation is shown in FIG. 7, below. If the user does not select a check cashing operation, the example process 400 does not continue operation, as operational flow branches “no” to an exit point 408, leading to an alternate flow relating to the other options for financial transactions presented to the user. If the user does select a check cashing operation, the example process 400 branches “yes” at a credential entry subsection 410 of the process.

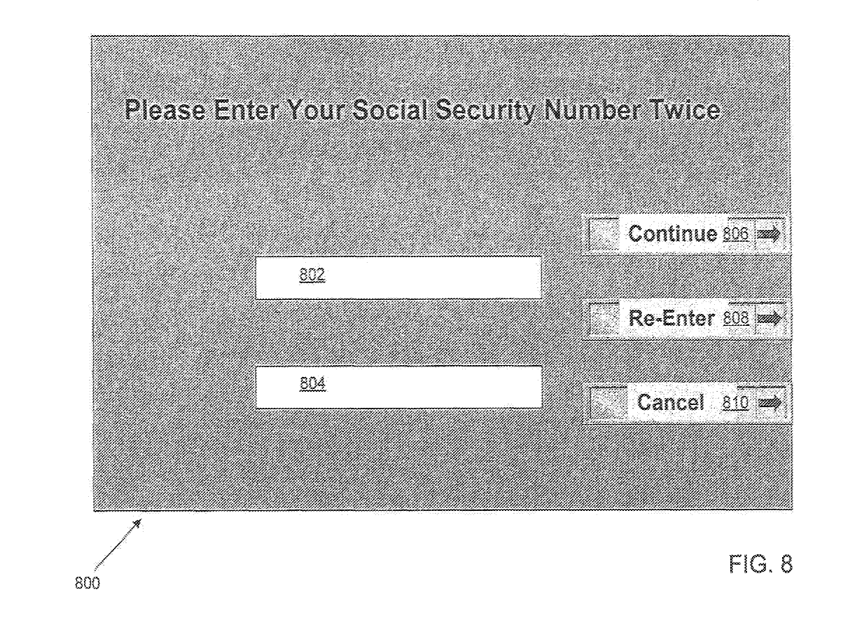

The credential entry subsection 410 generally receives credential information and validates that the user is in fact the person at the kiosk. The credential entry subsection 410, overall, is used to link accounts (e.g. an account at the transaction location and/or an account at one or more financial institutions) to that user. In the embodiment shown, the credential entry subsection 410 includes a first identification code receipt module 412, which receives a code entered by a user for self identification. In the current embodiment, this identification code is shown as a social security number (SSN); however, other possibly unique codes or words can be used as well, such as a driver's license number, employee identification code number, a full name and address, or other information. An identification code confirmation module 414 requests and receives reentry of the identification code from the user to validate correct entry of the identification code. One example user interface presentable for use in conjunction with the modules 412, 414 is shown in FIG. 8, below.

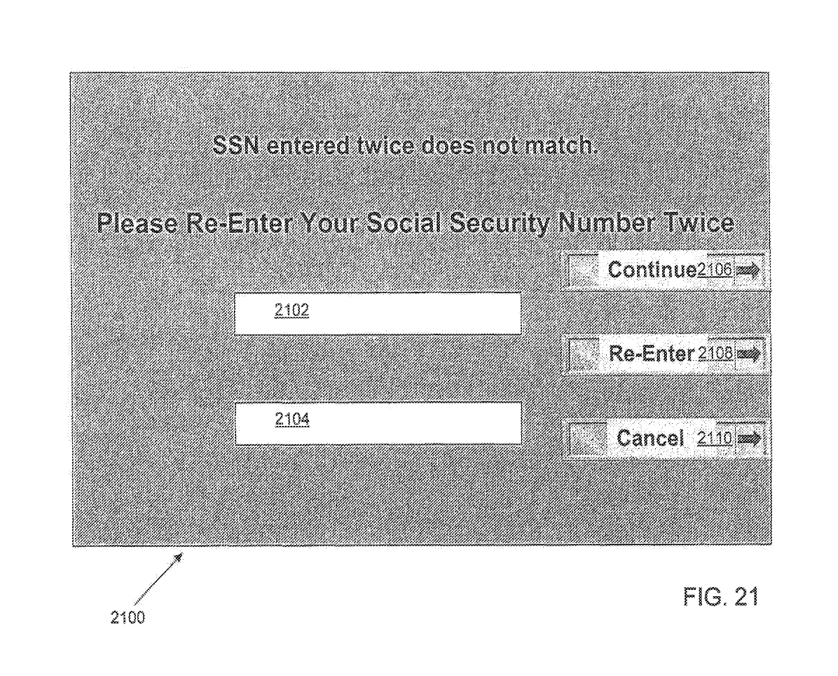

A matching operation 416 determines whether the codes received by modules 412, 414 match; if the entries do not match, operational flow within the process 400 branches “no” to the first identification code receipt module 412, to retry identification code entry (e.g. as shown in the user interface of FIG. 21, below).

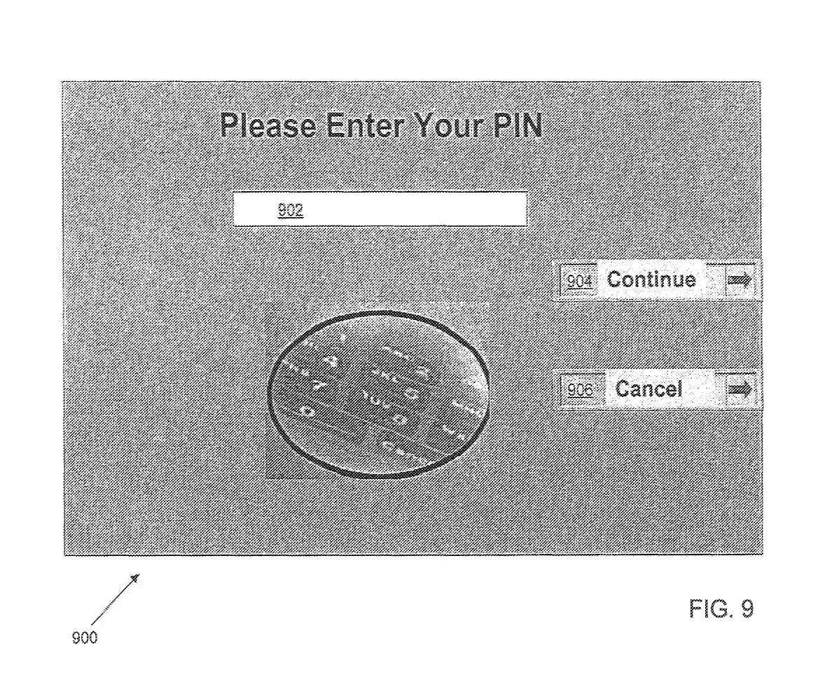

If the entries match, operational flow within the process branches “yes” to an identification number entry module 418. The identification number entry module 418 receives entry of an identification number assigned to the user and useable as a personal security confirmation number known only to the user. In various embodiments, the identification number can be a PIN or password able to be entered by the user at the transaction location, such as an alphanumeric code. Other possibilities, such as receipt of a fingerprint or other unique biometric data, may exist as well. One example user interface presentable by the identification number entry module is shown in FIG. 9, below.

In certain embodiments, the entered identification number is not displayed in the same manner in which it is typed by the user. For example, the number can be masked on the display to indicate the number of digits typed by the user, without displaying the specific code. This provides feedback to the user relating to successful entry of the code digits, while preventing unintentionally displaying the code to other individuals in proximity to the user.

In certain embodiments of the process 400, it may be required to reenter the identification number entered into the module 418. For example, if the user is setting up a personal identification number for the first time, or the user has entered an incorrect number, reentry may be required to validate correct entry of the identification number. If such reentry is required, operational flow proceeds to an identification number reentry module 420. The reentry module generally corresponds to subsequent operation of the identification number entry module 418 in terms of operation and display to the user.

If no reentry is required (e.g. by reentry determination operation 419), or if a user has already entered the identification number twice (using modules 418, 420, respectively), operational flow proceeds to an identification number validation operation 422. The identification number validation operation determines whether the identification number entered by the user matches the reentered identification number. If some mismatch exists, operational flow branches “no” to the identification number entry module 418 to retry the overall identification number entry process (as embodied in modules 418-422).

If no mismatch exists, operational flow branches “yes” to a user information retrieval module 424. The user information retrieval module 424 submits the received identification number and associated user identifier previously entered. In the embodiment shown, the user information retrieval module 424 is performed at a host computer at the transaction location or offsite, such as at the risk assessment location. Other possible locations may be used as well.

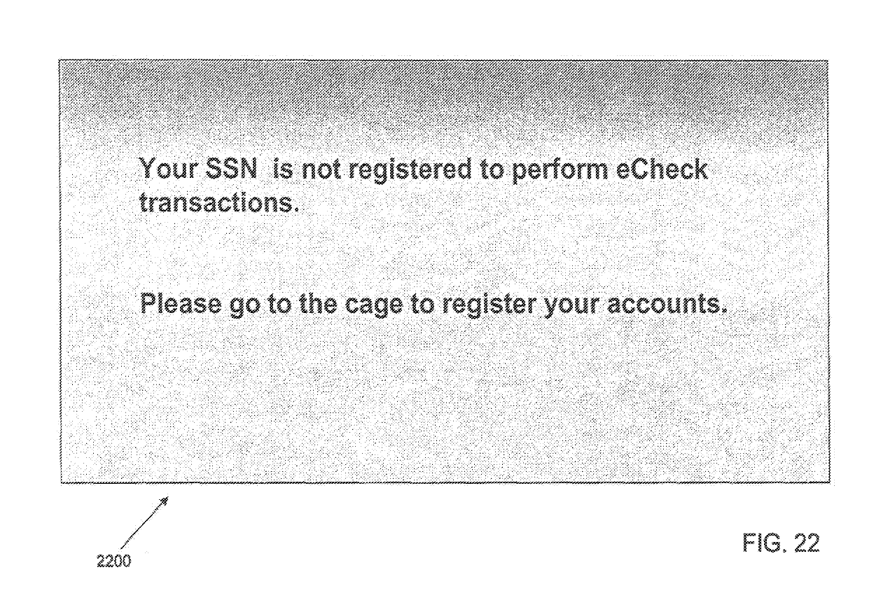

Reference marker A indicates continuation of the process 400 onto FIG. 5. Now referring to that figure, from reference marker A, operational flow proceeds to a validation operation 426. The validation operation 426 determines, based on the information returned to the localized transaction location (e.g. the kiosk or other computing system) whether the login information successfully correlated to an account, and whether a proper identification code for the account has been provided. If the identification code entered in modules 412, 414 is not stored on the host computer (e.g. locally, or at the risk assessment location), operational flow branches “Not on Host” to a referral module 428, which refers the user to a customer service representative to set up an account at the transaction location (e.g. using a message such as the one shown in FIG. 22, below). In certain embodiments, the customer service representative works with the user to set up an account using the Certegy E-CAGE system platform previously mentioned.

If the identification code entered in modules 412, 414 is valid but the associated identification number (e.g. PIN number) does not match that user's code, operational flow branches “Invalid” to an identification number reset portion 430 of the process 400. If the identification code and identification number both correspond to an account, operational flow branches “yes” to a checking account withdrawal portion 432 of the process 400.

The identification number reset portion 430 is instantiated at a code reset module 434. The code reset module 434 displays to the user the options of either (1) resetting their identification code, if unknown, or (2) retrying entry of the reset code. A selection operation 436 detects user selection of one of these options. If the selection operation detects that the user has selected to retry entry of the identification code, operational flow proceeds to a reentry module 438. The reentry module 438 receives reentry of an identification code from the user, as previously described. A validation module 440 validates the newly-entered identification code (e.g. PIN) against the valid identification number (e.g. SSN) received from the user. If the number is valid, then operational flow branches “yes” and returns to the checking account withdrawal portion 432 of the process, as indicated by redirection indication C.

If the user selected to reset their identification code, or if the number is not valid (as indicated by redirection indication C), operational flow branches “reset” to a keyword entry module 442. The keyword entry module receives entry of a keyword by a user, relating to personal knowledge of the user. For example, the keyword entry module 442 can receive information about the user, such as the birthdate, mother's maiden name, or other information from the user. A keyword validation module 444 determines whether the keyword entered by the user matches a keyword previously provided to the system executing the process 400. If the keyword matches, operational flow branches “yes” to a reset module 446, which resets the identification code of the user. Operational flow returns to the checking account withdrawal portion 432 of the process, as indicated by redirection indication C. If the keyword does not match, operational flow branches “no” to a referral module 448 which refers the user to a customer service representative, such as an individual operating a Certegy E-CAGE system platform previously mentioned.

At this point in the process 400, the user credentials are successfully validated at the system managed at the transaction location, such that the system can have confidence that the individual at the kiosk is in fact the person associated with a local account. The person is therefore also associated with an identified account at a financial institution, as described above in conjunction with FIG. 2. The checking account withdrawal portion 432 is instantiated at a guideline display module 450, which displays a number of guidelines to the user regarding use of the process 400. These guidelines can include minimum and maximum dollar amounts to allow for the electronic check, as well as indications that the electronic check cashing operation is implemented using the Automated Clearing House (ACH) methodology. Additional guidelines can be displayed as well, such as an indication that the process is to be used with respect to personal checking accounts. In certain embodiments, the guideline display module 450 can display personalized information to the user based on known accounts, credit lines, and other financial information associated with the user, such as daily account limits or other information about possible transactions the user can perform at the transaction location.

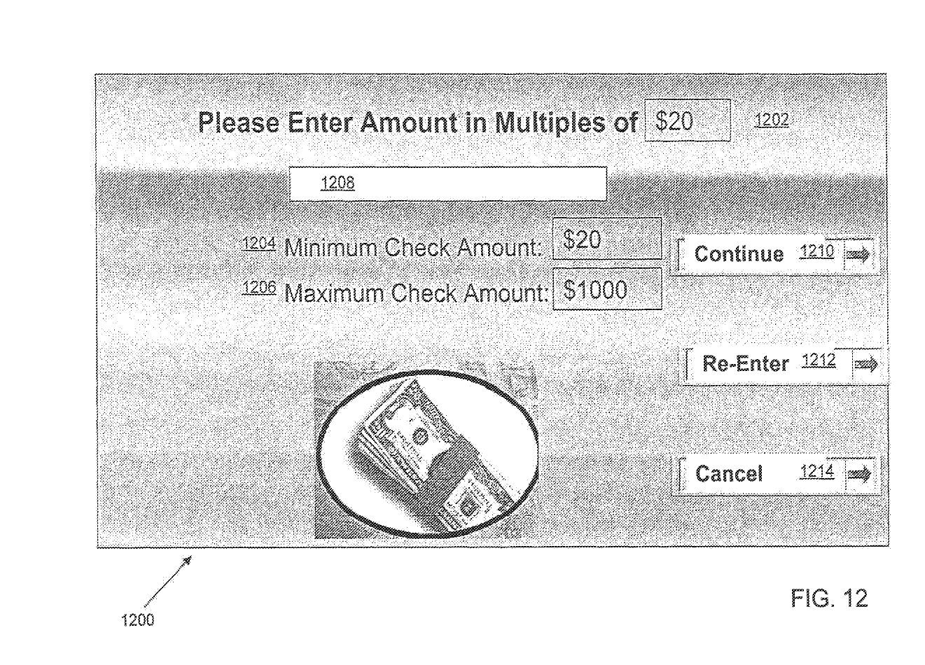

Operational flow proceeds to a fund request module 452, which receives from a user an indication of the amount of funds to be withdrawn from that user's checking account. The fund request module 452 can display additional messages to the user as well, such as information about limits on numbers of transactions, currency dispensed, and denominations available at the kiosk or other system at the transaction location. One example user interface presentable by the fund request module 452 is shown in FIG. 12, below.

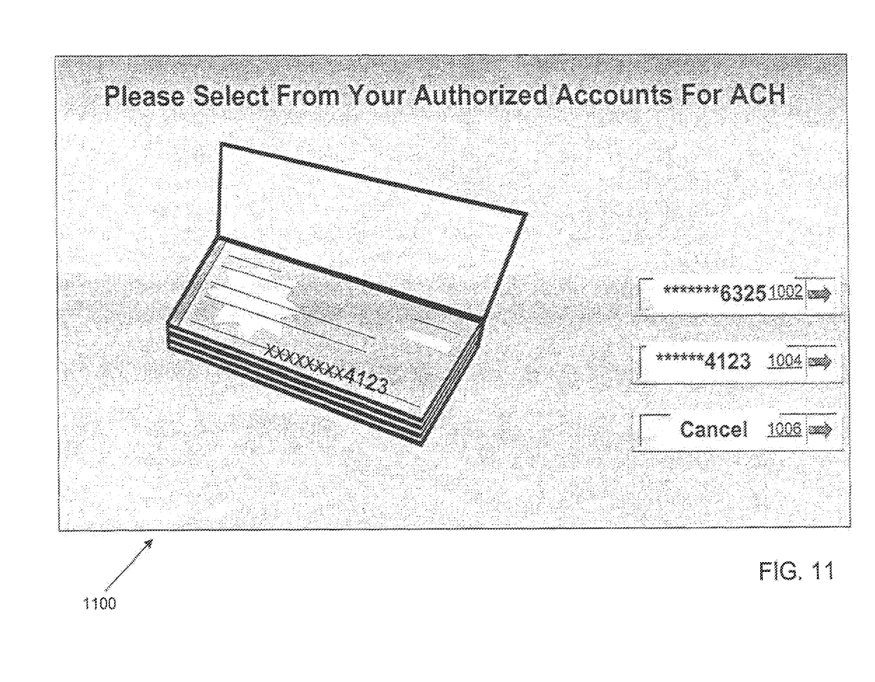

Optionally, if the user is associated with one or more accounts, the guidelines display module 450 or fund request module 452 can be configured to display a description of each account associated with that user, and request selection of one of the accounts for forming an electronic check transaction to be used. One example user interface presentable for making such a selection is shown in FIG. 11, below.

Operational flow proceeds to a fee calculation module 454, which accesses a fee calculation table to determine a fee to be charged to the user for making a withdrawal from a checking account using the process 400. In various embodiments, the fee can correspond to a flat fee, or can correspond to a fee based on the amount of money to be withdrawn. For example, because a user withdrawing a large amount of money via electronic check at the transaction location will likely spend at least a part of that money at the transaction location, the fee calculation table may indicate a lower or different fee for that withdrawal than withdrawals of smaller amounts of money. In embodiments employing no fees, the fee calculation table is filled with zeros. Other arrangements are possible as well.

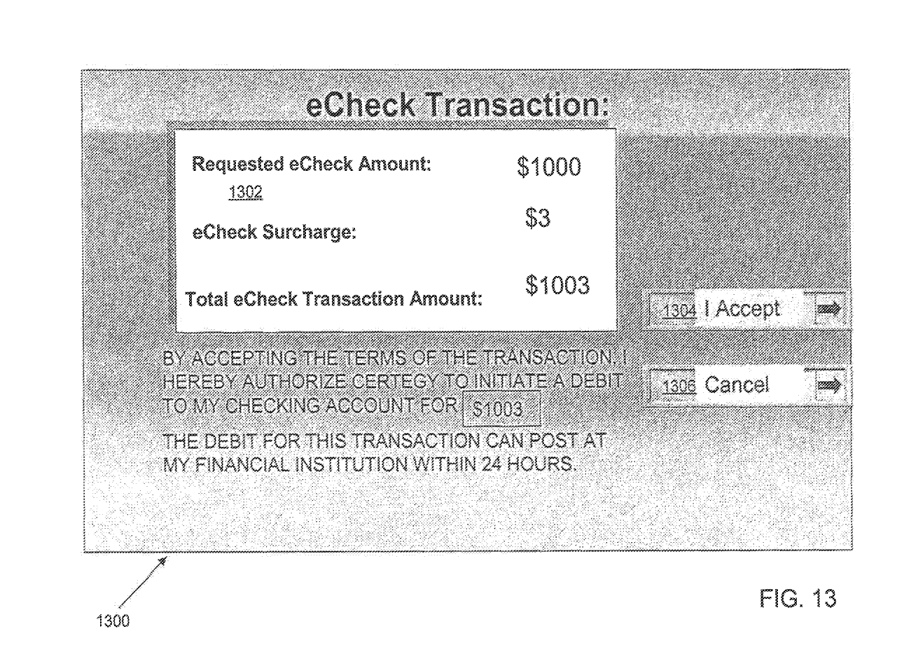

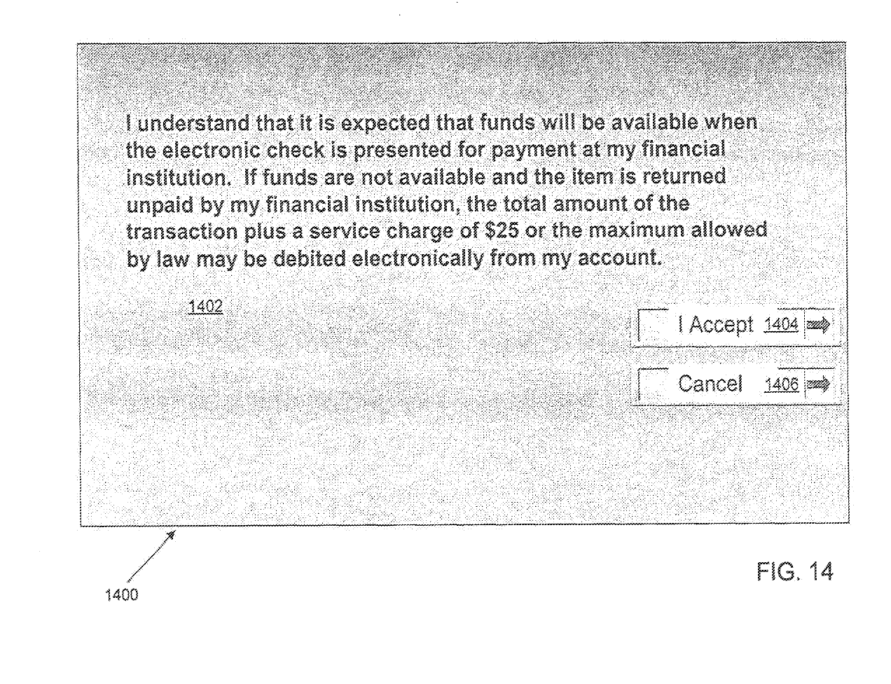

A fee acceptance display module 456 generates a fee acceptance screen displaying the calculated fee to the user, alongside the other transaction details (account number, amount to be debited) and requests approval from the user prior to submitting the now-formed electronic check. The fee acceptance display module 456 can also optionally indicate to the user the delay between the request for funds and settlement of the checking account debit. One example user interface presentable by the fee acceptance display module 456 is shown in FIG. 13, below. An acceptance operation 458 determines whether the user has accepted the fee and transaction specifics. If the user does not accept the fee, operational flow branches “no” to a cancellation module 460, which cancels the transaction and logs the user out of the kiosk or other computing system executing the process 400. If the user does accept the fee, operational flow proceeds to a transaction request display module 462. The transaction request display module 462 displays details of the transaction request, including details regarding a user's rights with respect to an Automated Clearing House (ACH) transaction to issue a debit transaction (e.g. the electronic check) to the checking account of the user. One example user interface presentable in conjunction with the transaction request display module 462 is shown in FIG. 14, below.

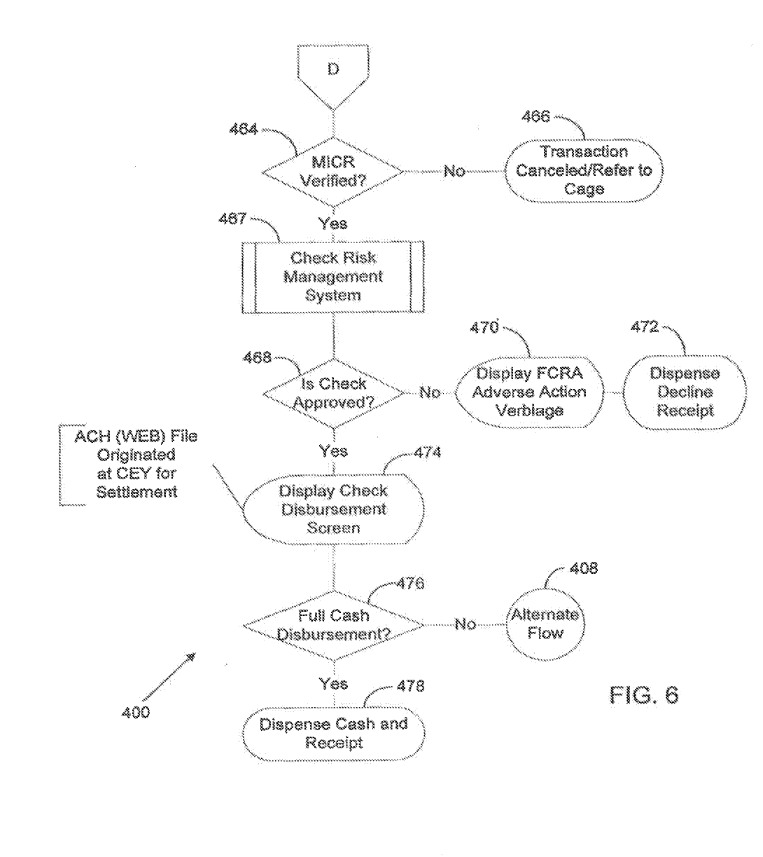

Operational flow follows off-page reference D to FIG. 6, which continues the process 400. Now referring to that figure, a verification operation 464 verifies whether the routing information in the ACH transaction is correct with respect to the account selected by the user. In typical embodiments, the routing information corresponds to the magnetic ink character information (MICR) printed on a check and including the account number and routing number for the checking account. Other routing information can be included as well. If the information is incorrect, operational flow branches “no” to a referral module 466, which refers the user to a customer service representative, such as an individual operating a Certegy E-CAGE system platform previously mentioned, for correcting the routing information.

If the information is verified successfully by the verification operation 464, operational flow branches “yes” to a risk management module 467. The risk management module receives the now-completed ACH transaction information and performs a risk assessment on the transaction represented by that information. For example, the risk management module 467 can determine, based on information received from financial institutions for accounts associated with the user, a maximum allowable withdrawal rate over a specific window of time, for a specific user or account, and can determine whether the requested transaction fits within those parameters. The risk management module 467 can periodically update its information related to the accounts, to provide improved or worse approval terms with respect to the accounts it assesses.

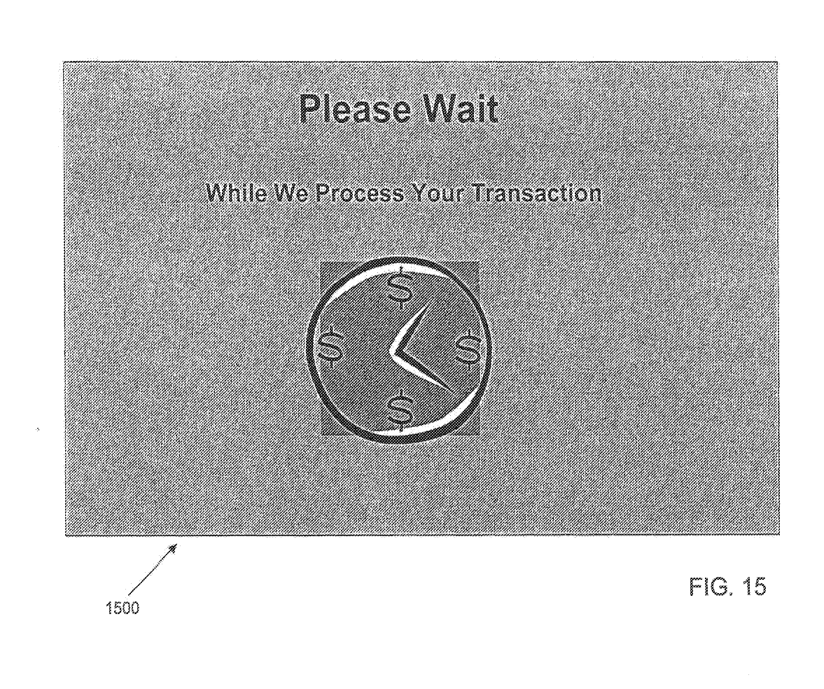

Within the context of the network 200 of FIG. 2, the risk management module 467 operates at the risk management location 206, which receives the ACH transaction information via the network 208 from one of the kiosks or other computing systems at the transaction location 202. Therefore, there is required a substantial amount of data communication between a transaction location and the risk management location. Optionally, the kiosk or other computing system in operation can display a wait screen (e.g. the screen shown in FIG. 15 below) while awaiting a return from the risk management module 467.

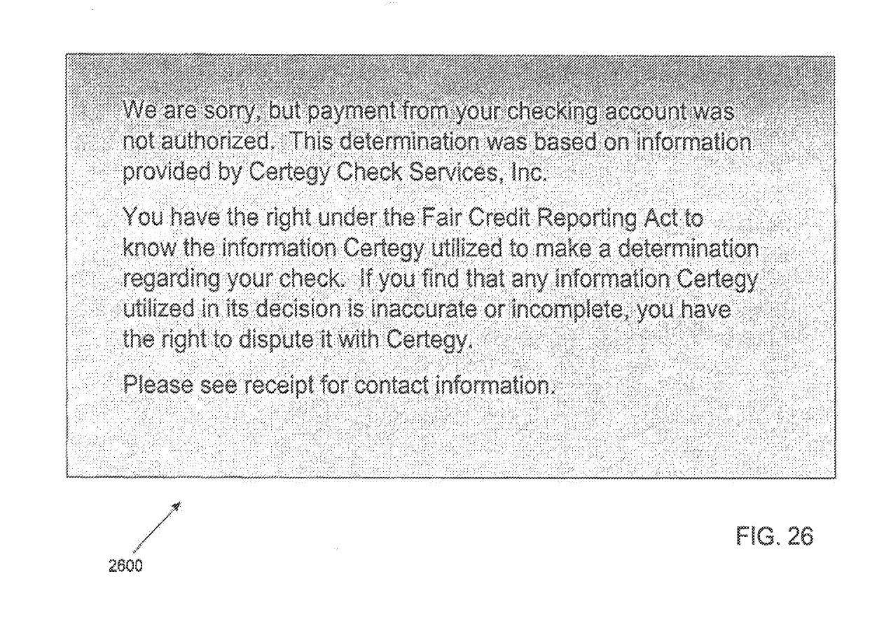

The risk management module 467 returns an indication of the acceptance or rejection of the ACH electronic check transaction to the kiosk or computing system operated by the user, as well as details regarding that acceptance or rejection. For example, the risk management module 467 can have assigned task codes associated with any of a number of decisions, such as approval or declining of a transaction, declining an ACH operation, a failure to process the transaction message, or other errors. The kiosk or computing system operated by the user then performs an assessment of the returned data at an approval determination operation 468. If the approval determination operation 468 determines that the risk management module 466 has rejected the transaction, operational flow branches “no” to an adverse action communication module 470, which displays a message (e.g. the message shown in FIG. 26) to the user indicating an adverse decision regarding the request to withdraw funds. The message, in various embodiments, includes FCRA-compliant adverse language, identifying specific corrective or remedial action that can be taken by the user based on the adverse action. A dispenser module 472 dispenses a receipt to the user indicating that the adverse decision was taken.

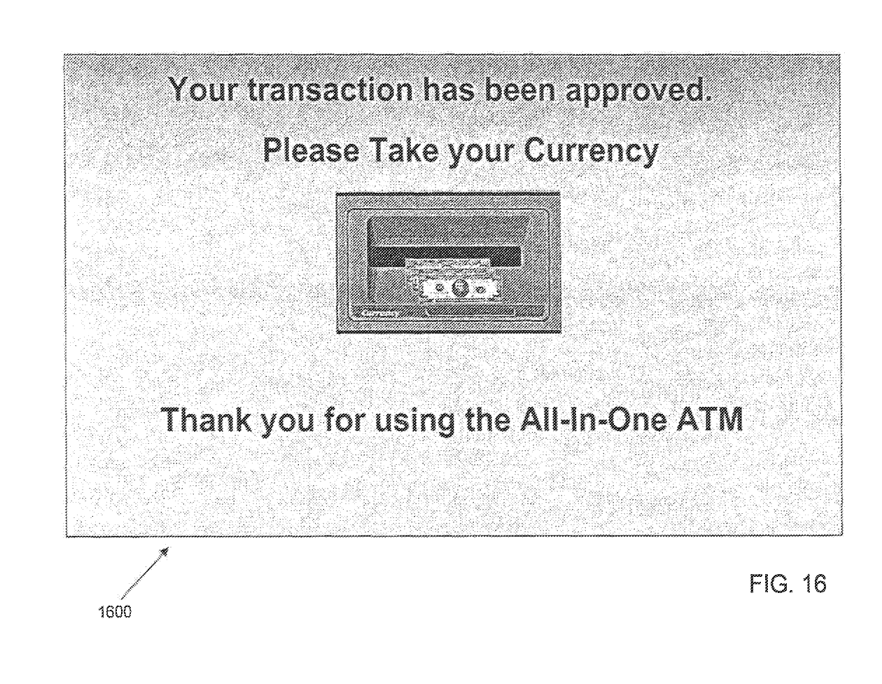

If the approval determination operation 468 determines that the ACH transaction is approved, a disbursement display module 474 displays a successful disbursement message (e.g. the message shown in FIG. 16), and activates a cash disbursement mechanism in the kiosk. A disbursement monitor operation 476 ensures that a full cash disbursement occurs. If for some reason less than an entire cash disbursement occurs (e.g. the kiosk has run out of currency, is jammed, etc.), operational flow proceeds to an alternative flow from the process 400, such as to a technical debugging software application to determine potential issues with respect to the mechanical components of the kiosk or computing system. In certain embodiments, the alternative flow proceeds to refer the kiosk to personnel at the transaction location who are responsible for cash handling. If an entire cash disbursal occurred, operational flow proceeds to a confirmation module 478, which dispenses a receipt and the entire cash amount to the user, thereby completing the ACH transaction from the user's perspective.

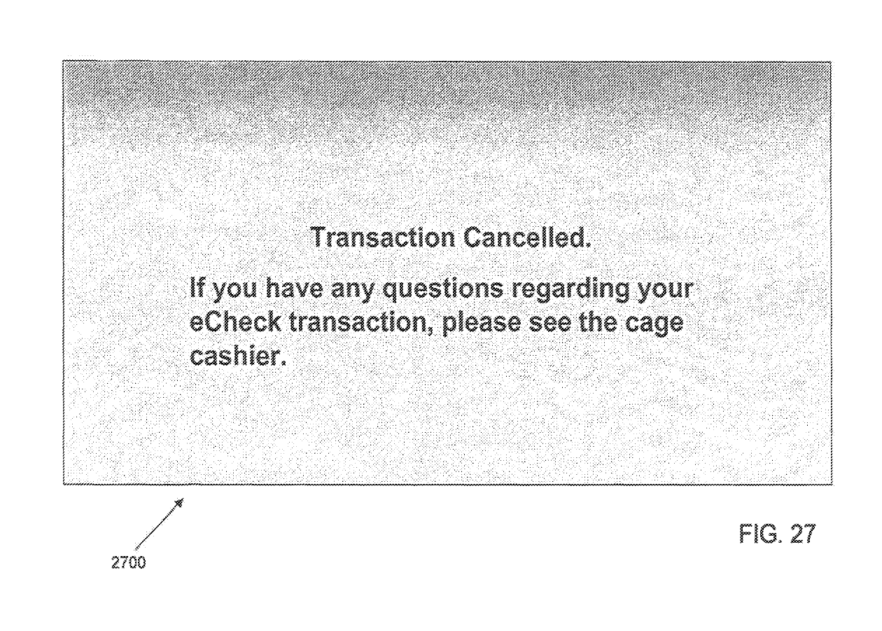

Throughout operation of the electronic check cashing process 400, the user has the option to cancel the process, discontinuing the request for withdrawal of funds from their checking account. The user can be presented with a cancel option in each display to ensure that, at the point the user wishes to cease his/her request, the process can be discontinued. A confirmation message can be presented to the user, such as the message shown in FIG. 27.

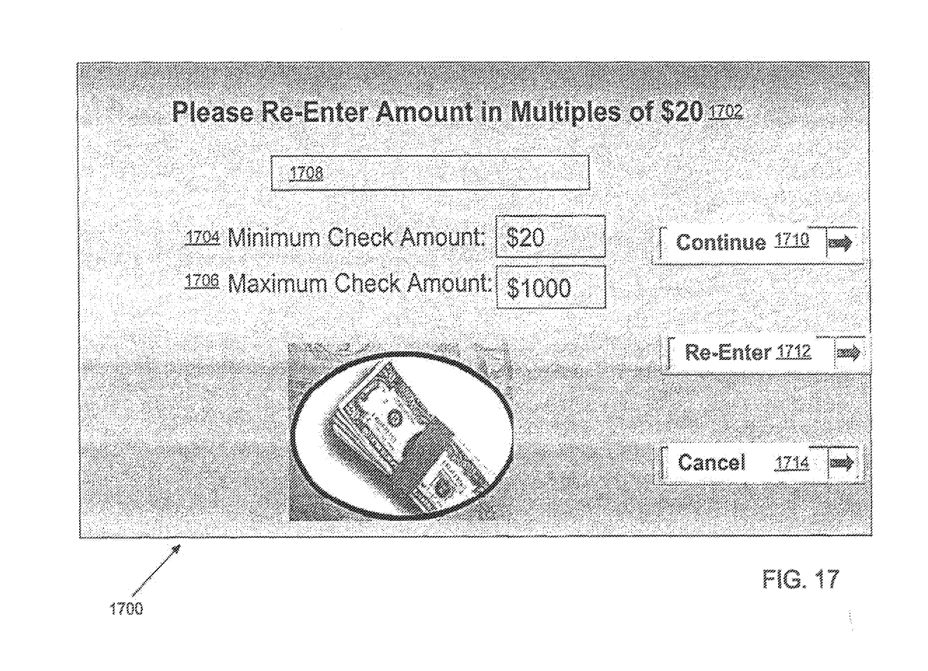

Referring now to FIGS. 7-27, additional description of various graphical user interfaces is provided. The graphical user interfaces are example displays that can be used for interaction with a user at a kiosk or other computing system configured to execute the systems and methods described herein, and to disburse funds or a receipt to claim such funds. In general, FIGS. 7-16 illustrate user interfaces required for a single successful electronic check cashing operation; FIGS. 17-27 illustrate example user interfaces used to correct certain possible errors in the electronic check cashing process (either human or machine errors).

FIG. 7 illustrates a graphical user interface 700 for obtaining funds from a personal checking account, useable in certain embodiments of the checking account withdrawal system of the present disclosure. The graphical user interface 700 can be displayed to a user to indicate the generalized parameters of the kiosk or computing system, as discussed above in conjunction with the welcome screen module 402 or check cashing operation 406 of FIG. 4, above. The graphical user interface includes fund limit information 702 and settlement timing information 704, relating to when the electronic check withdrawal will occur. A continue button 706 allows a user to continue and initiate a check cashing process, while a cancel button 708 allows the user to discontinue the process and log out of the kiosk and checking withdrawal system overall.

FIG. 8 illustrates an example graphical user interface 800 for entering user credentials, useable in certain embodiments of the electronic check cashing system of the present disclosure. The user interface 800 can be used for collection of an identification number (e.g. a social security number, as shown), as indicated in modules 412, 414 of FIG. 4, above. The user interface 800 includes first and second identity number regions 802, 804 for entering and reentering an identification code, as well as a continue button 806, a re-enter button 808, and a cancel button 810. Other options can be included in the graphical user interface as well.

Referring now to FIG. 9, an example graphical user interface 900 for receipt of an identification number (e.g. PIN number) associated with the user having the identification code entered into the user interface of FIG. 8 is shown. The user can enter the identification number in field 902, and press either the continue button 904 to proceed with the checking account withdrawal, or the cancel button 906 to discontinue the process and log out of the kiosk and checking withdrawal system overall. In the embodiment shown, the identification number entry field 902 can provide for blind entry of an identification number for security reasons; however, other arrangements accommodating user privacy (screen shields, etc.) could be implemented as well.

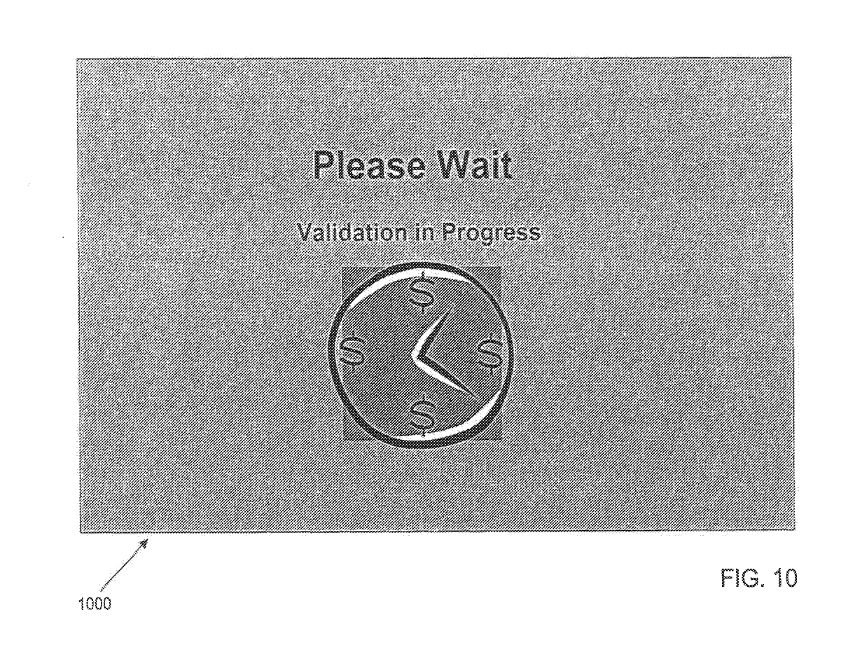

FIG. 10 illustrates an example graphical user interface 1000 presentable during a login processing stage, useable in certain embodiments of the electronic check cashing system of the present disclosure. The user interface 1000 can be displayed, for example, on a kiosk while that kiosk transmits the identification code and identification number to a remote computing system (either a local host or a remote system, such as a system at the risk assessment location) and receives an indication of the user's ability to perform a checking account withdrawal using the systems and methods described herein.

FIG. 11 illustrates an optional graphical user interface 1100 for selecting an account as previously described in conjunction with the guidelines display module 450 or fund request module 452, useable in certain embodiments of the electronic check cashing system of the present disclosure in which a user is associated with more than one checking account. In the embodiment shown, the graphical user interface includes a button associated with each account (buttons 1102, 1104), with the last four digits of the account number displayed for identification purposes. A cancel button 1106 allows the user to cancel the checking account withdrawal process and log out of the kiosk and checking withdrawal system overall.

FIG. 12 illustrates a further example graphical user interface 1200, for selecting an amount relating to an electronic check cashing transaction. The graphical user interface includes a message 1202 regarding the types of amounts acceptable to the kiosk or computing system operating the processes described in the present disclosure, as can be dictated by the currency denominations stocked in that system. The user interface 1200 also includes message fields 1204, 1206 indicating the minimum and maximum check amounts acceptable to the system. A field 1208 receives the amount requested by the user, and a continue button 1210 confirms receipt of the field amount. A reenter button 1212 allows reentry of the amount in the field, if required. A cancel button 1214 allows the user to cancel the electronic check cashing process and log out of the kiosk and checking withdrawal system overall.

FIG. 13 illustrates an example graphical user interface 1300 for confirming a transaction relating to an e electronic check cashing process, useable in certain embodiments of the electronic check cashing system of the present disclosure. The user interface 1300 includes a region 1302 that displays information associated with a electronic check cashing transaction, including the requested amount, applied fees, and total amount, as described above in conjunction with the fee acceptance display module 456 of FIG. 5. The user interface 1300 also includes various terms for the withdrawal transaction, as well as an accept button 1304 to proceed with the transaction, or a cancel button 1306 which allows the user to cancel the checking account withdrawal process and log out of the kiosk and checking withdrawal system overall.

FIG. 14 illustrates an example graphical user interface 1400 displaying notice provisions relating to an electronic check cashing transaction. The user interface 1400 provides a display region 1402 for the information generated and displayed by the transaction request display module 462 of FIG. 5. Analogously to the user interface 1300 of FIG. 13, the user interface 1400 also includes various terms for the electronic check cashing transaction, as well as an accept button 1404 to proceed with the transaction, or a cancel button 1406 which allows the user to cancel the checking account withdrawal process and log out of the kiosk and checking withdrawal system overall. In alternate embodiments of the graphical user interface 1400, different or additional notice provisions can be displayed as well.

FIG. 15 illustrates a graphical user interface 1500 presentable during a transaction processing stage, useable in certain embodiments of the electronic check cashing process of the present disclosure. The graphical user interface 1500 can be presented during processing by the risk management module 467, and associated data communication between the transaction location 202 and the risk management location 206. FIG. 16 illustrates an graphical user interface 1600 presentable after successful approval of an electronic check withdrawal, and disbursement of funds according to the system as generally described in conjunction with FIG. 6.

Referring now to FIGS. 17-27, various additional user interfaces are shown according to an embodiment of the present disclosure in which additional input is required of the user, for example due to incorrect entry, a lack of a preexisting account arranged at the transaction location (e.g. in the E-CAGE system), a canceled checking account withdrawal, or other exception process flow.

FIG. 17 illustrates a graphical user interface 1700 that requests a electronic check confirmation, useable in situations in which a user enters an invalid amount of money into the user interface 1200 of FIG. 12. The user interface 1700 includes analogous components to the user interface 1200, including a message 1702 regarding the types of amounts acceptable to the kiosk or computing system, message fields 1704, 1706 indicating the minimum and maximum check amounts acceptable to the system, field 1708 that receives the amount requested by the user, and a continue button 1710 that confirms receipt of the field amount. A reenter button 1712 allows reentry of the amount in the field, if required. A cancel button 1714 allows the user to cancel the checking account withdrawal process and log out of the kiosk and checking withdrawal system overall. Upon proper use of the interface 1700, the “normal” process described above in FIGS. 7-16 can be resumed at FIG. 13.

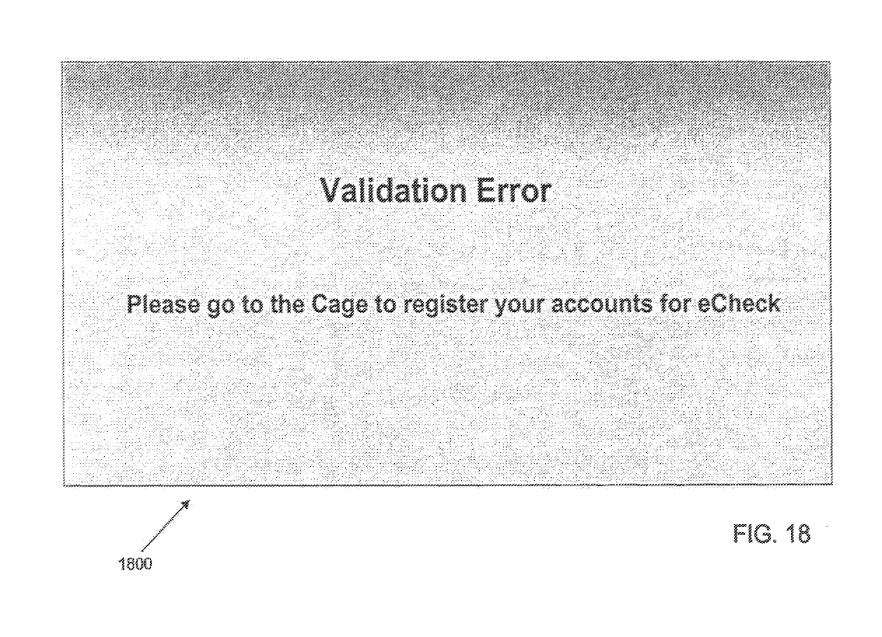

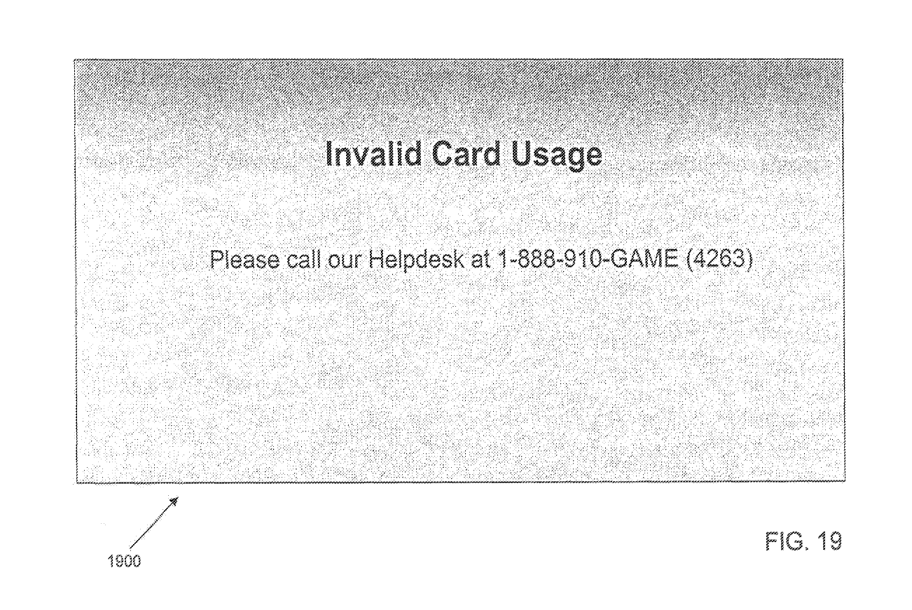

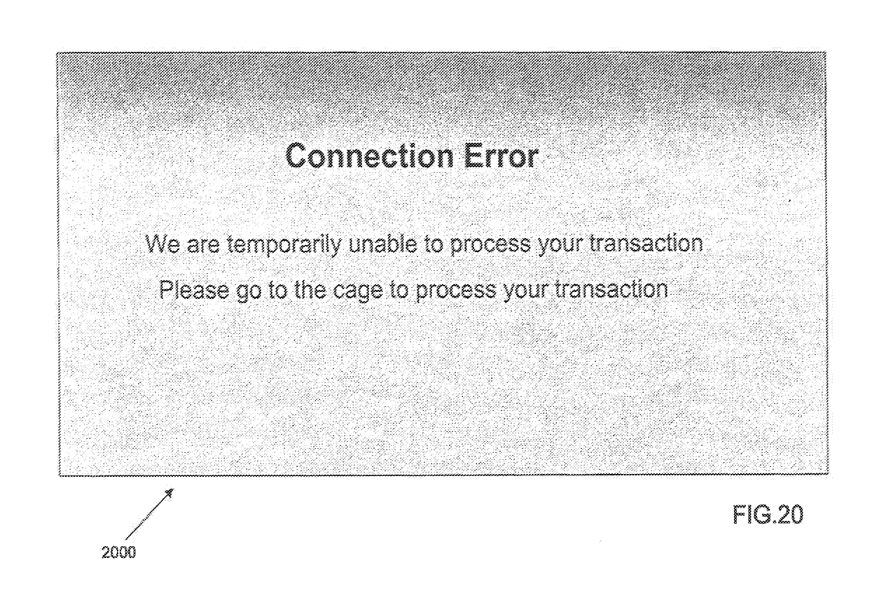

FIG. 18 illustrates a graphical user interface 1800 reporting a validation error, and referring the user to the E-CAGE system as indicated in conjunction with the various referral modules described above in conjunction with FIGS. 4-6. FIG. 19 illustrates a graphical user interface 1900 reporting invalid card usage, such as could occur during use of an identification card encoding information about a user. FIG. 20 illustrates an example graphical user interface 2000 reporting a connection error. Various messages can be incorporated on these user interfaces, indicating that the kiosk or computing system used cannot process the checking account withdrawal as requested.

FIG. 21 illustrates an example graphical user interface 2100 reporting an incorrectly entered identification code in an example of providing user credentials in the electronic check cashing systems disclosed herein. The example graphical user interface generally corresponds to the user interface of FIG. 800, and includes first and second identity number regions 2102, 2104 for entering and reentering an identification code, as well as a continue button 2106, a re-enter button 2108, and a cancel button 2110. Other options can be included in the graphical user interface as well. Upon proper use of the interface 2100, the process described above in FIGS. 7-16 can be resumed at FIG. 9.

FIG. 22 illustrates a graphical user interface 2200 for a credential disabling message, useable in certain embodiments of the electronic check cashing system of the present disclosure. The user interface 2200 can be displayed, for example, when no identification code (e.g. a social security number) matches an account managed at the transaction location. The user interface can be displayed as a possible result of a failed operation of the user information retrieval module 424 to find an account matching an identification code, as described above.

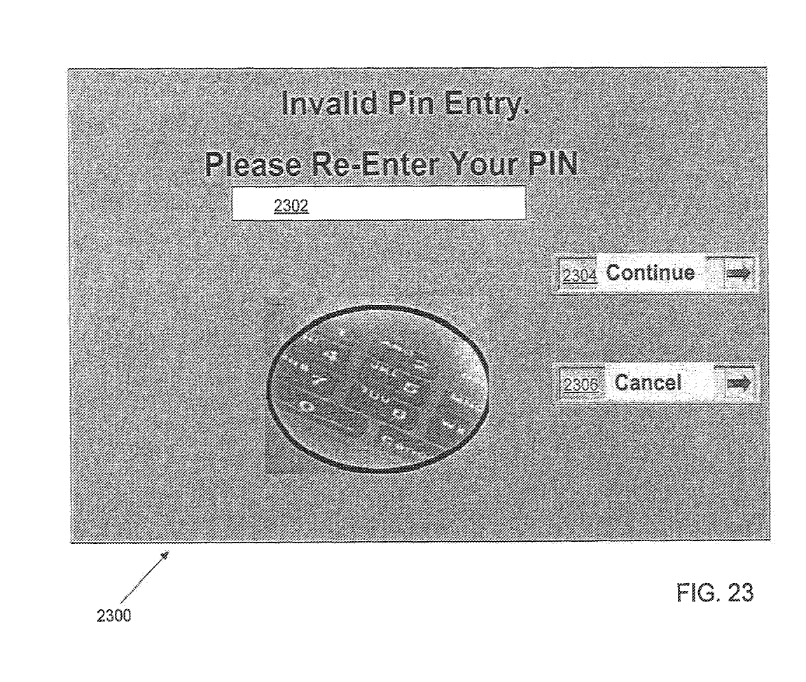

FIG. 23 illustrates an example graphical user interface 2300 reporting that an identification number used as a user's credentials is invalid. In this instance, the graphical user interface 2300 may flash prior to allowing a user to retry entry of an identification number such as using the interface 900 previously described. Upon proper use of the interface 2300, the process described above in FIGS. 7-16 can be resumed at FIG. 10.

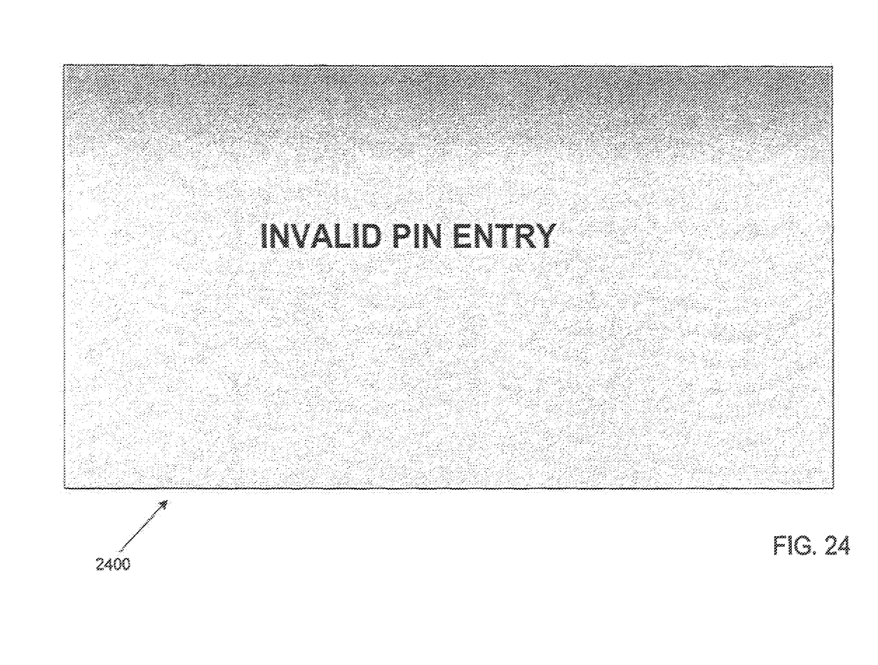

FIG. 24 illustrates an example graphical user interface 2400 reporting that an identification code used as a user's credentials is invalid (e.g. after a user is requested to create a PIN code or other identification number). This interface can be displayed if the user enters credentials that are outside the acceptable bounds for an identification number (e.g. based on the existence of too many or too few characters, repeated characters, or other security concerns.)

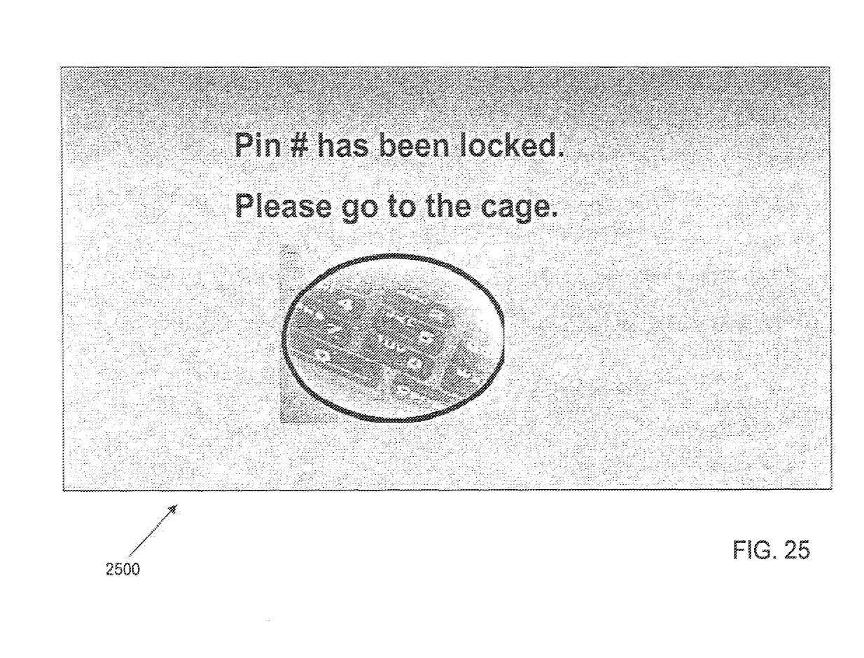

FIG. 25 illustrates an example graphical user interface 2500 reporting that an identification number used as a user's credentials is invalid (e.g. after a user fails to reenter the identification code using the user interface of FIG. 23). The user interface generally corresponds to failed reentry of an identification number, as described above in conjunction with FIG. 4.

FIG. 26 illustrates an example graphical user interface 2600 for reporting a rejected transaction, useable in certain embodiments of the electronic check cashing system of the present disclosure. The graphical user interface can be displayed, for example, in the case the risk assessment module 467 of FIG. 5 determines that the ACH transaction received from the user should be rejected, and can correspond to output of the kiosk or computing system during or following operation of the adverse action communication module 470.

FIG. 27 illustrates an example graphical user interface 2700 associated with a canceled transaction. The user interface 2700 can be displayed upon user selection of a cancel option on one of the other user interfaces described herein, such as the interfaces shown in FIGS. 7-9 and 11-14, above, prior to resetting the systems and methods for subsequent use by the same or a different user.

Although specific user interfaces are described in conjunction with certain embodiments of the present disclosure, it is understood that additional functionality of the overall systems can be included as well, and additional information can be included in the user interfaces displayed. The user interfaces shown in FIGS. 7-27 are intended merely as examples, and the appearance of these interfaces is not intended to provide functional limits on the capabilities of the systems and processes described herein.

Overall, it can be seen that, through use of the methods, systems, and interfaces of the present disclosure, an electronic check cashing system can be provided in which an electronic check cashing transaction, analogous to those performed in a check clearance process, can be accomplished at transaction locations managing cash dispensing operations (e.g. gaming establishments or other institutions). The present systems and methods allow withdrawal of funds from a checking account using a risk management system to determine the likelihood that sufficient funds exist in the account under consideration, thereby avoiding access of account balances to determine the presence of funds. Furthermore, because current account balances generally can be inaccurate due to pending check clearances, in certain cases the present disclosure provides a method of cashing electronic checks that provides a more reliable method for transaction hosts to allow users to perform a personal check cashing operation.

The above specification, examples and data provide a complete description of the manufacture and use of the composition of the invention. Since many embodiments of the invention can be made without departing from the spirit and scope of the invention, the invention resides in the claims hereinafter appended.

1-20. (canceled)

21. A method for cashing an electronic check, the method comprising:
receiving a request to generate and cash an electronic check, the request including credential information from a user at an automated system communicatively connected to a checking account information database;
validating the credential information, wherein the validating comprises:
transmitting the credential information to a remote system hosting the checking account information database, and
receiving confirmation of acceptance of the credential information by the remote system;
obtaining, without capture of information from a physical check by the automated system, checking account information from the checking account information database, the checking account information corresponding to a checking account associated with the credential information and having been at least partially previously entered into the checking account information database prior to the quest to generate and cash the electronic check from a system separate from the automated system;
performing a risk assessment using the checking account information obtained from the checking account information database to determine whether the generate and cash the electronic check;
generating the electronic check based on the risk assessment; and
dispensing the cash to the user in an amount of the electronic check.

22. The method of claim 21, wherein the credential information includes an identification number of the user, and wherein the checking account information includes account information and routing information.

23. The method of claim 22, wherein the credential information includes an identification code previously selected by the user.

24. The method of claim 23, wherein the identification code is assignable by the user at the automated system.

25. The method of claim 23, wherein validating the credential information includes comparing the identification code and the identification number to previously stored credential information stored in the checking account information database.

26. The method of claim 21, wherein the risk assessment comprises determining a maximum amount of funds allowed to be withdrawn from the checking account associated with the electronic check within a predetermined period of time.

27. The method of claim 21, wherein receiving credential information comprises receiving identifying information from a user at least twice.

28. The method of claim 21, further comprising triggering disbursement of funds to the user from the automated system.

29. The method of claim 21, further comprising performing an automated clearing house transaction to cash the electronic check.

30. The method of claim 21, wherein the checking account information corresponds to a checking account held in the name of the user.

31. The method of claim 21, wherein the risk assessment further comprises generating a FCRA-compliant message to the user if the request to generate and cash the electronic check is rejected, the message identifying specific remedial available to the user based on the rejection.

32. A non-transitory computer storage medium comprising:
computer-executable modules stored in the computer storage medium, the modules configured to assist in electronically generating and cashing an electronic check at an automated system without capture of information from a physical check by the automated system, wherein the modules comprise:
a credential receipt module configured to receive credential information from a user at the automated system, wherein the automated system is communicatively connected to a checking account information database;
a validation module configured to validate the credential information received by the credential receipt module, the validation module being further configured to:
transmit the credential information to a remote system hosting the checking account information database, and
receive confirmation of acceptance of the credential information by the remote system;
an information module configured to obtain checking account information from the checking account information database, the checking account information corresponding to a checking account associated with the credential information and having been at least partially previously entered into the checking account information database from a system separate from the automated system prior to a request to generate and cash the electronic check;
a request receipt module configured to receive a request to generate and cash the electronic check drawn on the checking account; and
a determination module configured to determine whether to cash the electronic check, the determination comprising a risk assessment based on the checking account information obtained from the checking account information database.

33. The computer storage medium of claim 32, further comprising a disbursement module configured to trigger disbursement of the funds to the user from the automated system.

34. The computer storage medium of claim 32, further comprising a clearance module configured to perform an automated clearing house transaction to cash the electronic check.

35. The computer storage medium of claim 32, wherein the risk assessment determines a maximum amount of funds allowed to be withdrawn within a predetermined period of time.

36. A method of cashing an electronic check, the method comprising:
receiving credential information from a user at an automated system communicatively connected to a checking account information database, wherein the credential information comprises an identification number and security code;
validating the identification number and security code, the validating comprising:
transmitting the credential information to a remote system hosting the checking account information database, and
receiving confirmation of acceptance of the credential information by the remote system;
obtaining checking account information from the checking account information database, the checking account information corresponding to one or more checking accounts associated with the credential information and having been at least partially previously entered into the checking account information database from a system separate from the automated system;
prompting the user to select a checking account form among the one or more checking accounts;
receiving an indication from the user identifying the checking account for drawing the electronic check from among the one or more checking accounts;
receiving a request to generate and cash an electronic check associated with the checking account;
performing a risk assessment on the request prior to generating the electronic check to determine an amount of funds allowed to be withdrawn within a predetermined period of time;
performing an automated clearing house transaction to cash to the electronic check; and
triggering disbursement of the funds to the user form the automated system.

37. The method of claim 35, wherein the checking account information database resides on a computing system remote from the programmable circuit.

38. The method of claim 35, wherein the risk assessment comprises determining a maximum amount of cash that may be withdrawn from the checking account associated with the checking account information.

39. The method of claim 35, further comprising:
conducting a fee assessment to determine a fee to be charged to the user, the fee based on the amount of money to be withdrawn;
prompting the user to accept the fee; and
assessing the fee against the user upon receiving an acceptance based on the prompt.

40. The method of claim 35, wherein the risk assessment further comprises generating a FCRA-compliant message to the user if the request to generate and cash the electronic check is rejected, the message identifying specific remedial available to the user based on the rejection.
